(19) United States
(12) Patent Application Publication
(10) Pub. No.: US 2020/0390056 A1
(43) Pub. Date: Dec. 17, 2020

(54) VENTILATION SYSTEM FOR PIG-RAISING FACILITIES

(71) Applicant: SEOUL NATIONAL UNIVERSITY R&DB FOUNDATION, Seoul (KR)

(72) Inventors: In Bok LEE, Anyang-si, Gyeonggi-do (KR); Rack Woo KIM, Ansan-si, Gyeonggi-do (KR); Uk Hyeon YEO, Seoul (KR); Sang Yeon LEE, Seoul (KR); Jun Gyu KIM, Seoul (KR)

(73) Assignee: SEOUL NATIONAL UNIVERSITY R&DB FOUNDATION, Seoul (KR)

(21) Appl. No.: 16/975,344

(22) PCT Filed: Oct. 30, 2019
(86) PCT No.: PCT/KR2019/014418

§ 371 Date: Aug. 24, 2020

(30) Foreign Application Priority Data
Nov. 21, 2018 (KR) 10-2018-0144615

(51) Int. Cl. A01K 1/00; A01K 1/02

(52) U.S. Cl. CPC A01K 1/0052; A01K 1/0058; A01K 2227/108; A01K 1/0064; A01K 1/0209

(57) ABSTRACT

The present invention relates to a ventilation system for pig-raising facilities, comprising: a pig house (110) comprising a plurality of pig rooms (a) in which pigs are raised, and comprising an intermediate ceiling (113) and an upper ceiling (115) which are spaced apart from each other; a pit (120) provided at the bottom of the plurality of pig rooms (a); a plurality of roof exhaust fans (140) arranged at positions corresponding to the plurality of pig rooms (a), along the edge regions of the intermediate ceiling (113); and a plurality of air entry slots (150) provided in a plate surface of the intermediate ceiling (113) at constant intervals. At the front surface of the pig house (110), there are provided a lower window (114) which is provided between the intermediate ceiling (113) and the upper ceiling (115) and through which external air is introduced, and an upper window (116) which is provided between the upper ceiling (115) and a roof (112) and through which external air is introduced. At the rear surface of the pig house (110), lower exhaust fans (117) are provided to face the lower window (114), and upper exhaust fans (118) are provided to face the upper window (116).

### TECHNICAL FIELD

The present invention relates to a ventilation system for pig-raising facilities, and more particularly to a ventilation system for pig-raising facilities which may improve ventilation efficiency in the summer and the winter by separating air exhaust areas and air entry areas of a pig house from each other.

### BACKGROUND ART

In general, ventilation methods of pig houses are classified into a natural environment application method using the natural phenomenon of air flow, a forced ventilation method using mechanical force, and a combined method using the two methods complementarily.

Usually, the natural environment application method is used in pig houses for finishing pigs, and the forced ventilation method is used in windowless pig houses. In the forced ventilation method, intake holes and exhaust holes are mainly located in the side walls and the roof of a pig house and thus it is difficult to control an amount of ventilation and air flow, and the temperature of the air flowing into the pig house through the intake holes is very different from the internal temperature of the pig house and thus it is difficult to control the inner environment of the pig house.

Further, air exhausted to the outside after circulating the inside of the pig house includes various contaminants and bad smells generated from the inside of the pig house and may thus be subjected to purification treatment prior to exhaust, but the conventional wireless pig houses require installation of a purification treatment facility in a distributed manner in each of individual exhaust holes thereof and thus it is difficult to purify the exhausted air.

### DISCLOSURE

### Technical Problem

Therefore, the present invention has been made in view of the above problems, and it is an object of the present invention to provide a ventilation system for pig-raising facilities which may effectively perform ventilation of the inside of a pig house by separating an air intake path and an air exhaust path from each other.

It is another object of the present invention to provide a ventilation system for pig-raising facilities which may reduce an amount energy consumed to perform a heating operation and a cooling operation by controlling an air intake path differently in the summer and the winter.

It is a further object of the present invention to provide a ventilation system for pig-raising facilities in which air purification facilities may be installed in a non-distributed manner by disposing an air exhaust path in one place.

The above objects and other advantages of the invention will be set forth in part in the description which follows and in part will become apparent to those having ordinary skill in the art upon examination of the following or may be learned from practice of the invention.

### Technical Solution

In accordance with the present invention, the above and other objects can be accomplished by the provision of a ventilation system for pig-raising facilities including pig house (110) including plurality of pig rooms (a) in which pigs are raised and an intermediate ceiling (113) and an upper ceiling (115) which are spaced apart from each other, pits (120) provided at bottoms of the pig rooms (a), a plurality of roof exhaust fans (140) arranged at positions corresponding to the pig rooms (a), along edge regions of the intermediate ceiling (113), and a plurality of air entry slots (150) provided in a platy surface of the intermediate ceiling (113) at constant intervals, wherein a lower window (114) provided between the intermediate ceiling (113) and the upper ceiling (115) so as to introduce external air therethrough and an upper window (116) provided between the upper ceiling (115) and a roof (112) so as to introduce external air therethrough are provided on a front surface of the pig house (110), and lower exhaust fans (117) configured to face the lower window (114) and upper exhaust fans (118) configured to face the upper window (116) are provided on a rear surface of the pig house (110).

When the roof exhaust fans (140) and the lower exhaust fans (117) are operated to exhaust air in the pig rooms (a), contaminated air in the pig rooms (a) may be moved to the intermediate ceiling (113) through the roof exhaust fans (140), and exhausted to an outside through the lower exhaust fans (117).

The ventilation system for pig-raising facilities may further include side air guide pipes (160) configured to connect side walls (111) of the pig house (110) and an aisle (b) provided between neighboring pig rooms (a), each of the side air guide pipes may include a vertical pipe (161) provided parallel to the side walls (111) and a pit entry pipe (163) bent horizontally from the vertical pipe (161) and disposed between the pits (120) of the neighboring pig rooms (a), and a plurality of air exhaust holes (163a) configured to exhaust air towards the pits (120) may be provided through both sides of the pit entry pipe (163).

When the upper exhaust fans (118) are operated to allow external air to enter the pig rooms (a) in the summer, the external air may be moved to a space between the intermediate ceiling (113) and the upper ceiling (115) through the lower window (114), moved along the side air guide pipes (160), and supplied to areas under the pits (120) through the air exhaust holes (163a).

In the winter, the external air may be introduced into the pig house (110) through the lower window (114), and then introduced into the pig rooms (a) in a downward direction from upper regions thereof through the air entry slots (150) formed in the intermediate ceiling (113).

When hot air is accumulated in an area above the upper ceiling (115) in the summer, the upper exhaust fans (118) may be operated.

### Advantageous Effects

The ventilation system for pig-raising facilities according to the present invention uses an air intake path and an air exhaust path which are different from each other. Further, the ventilation system for pig-raising facilities according to the present invention may maintain an appropriate rearing environment in a pig house and minimize energy loss by controlling the air intake path differently in the summer and the winter.

In addition, the ventilation system for pig-raising facilities according to the present invention facilitates purification of contaminated air the unified air exhaust path. Thereby, emission of odors from the pig house may be reduced.

### DESCRIPTION OF DRAWINGS

FIG. 1 is a perspective view illustrating the overall configuration of a ventilation system for pig-raising facilities according to the present invention,

FIG. 2 shows front and rear views illustrating the front and rear surfaces of a pig house to which the ventilation system for pig-raising facilities according to the present invention is applied,

FIG. 3 is a cross-sectional view illustrating the inside of the ventilation system for pig-raising facilities according to the present invention,

FIG. 4 is a plan view illustrating a structure having pig pens and an aisle of the ventilation system for pig-raising facilities according to the present invention,

FIG. 5 is a view illustrating the structure of an intermediate ceiling of the ventilation system for pig-raising facilities according to the present invention,

FIG. 6 is a perspective view illustrating the configuration of a side air guide pipe of the ventilation system for pig-raising facilities according to the present invention, and

FIG. 7 is a schematic view illustrating an exhaust air purification structure of the ventilation system for pig-raising facilities according to the present invention.

### BEST MODE

Hereinafter, preferred embodiments of the present invention will be described in detail with reference to the accompanying drawings. The embodiments of the present invention may be variously modified, and it is interpreted that the embodiments described in detail below do not limit the scope of the invention. The embodiments have been disclosed for illustrative purposes to those skilled in the art. Therefore, in the drawings, the shapes of elements may be exaggerated so as to more clearly illustrate the embodiments. In the drawings, the same or similar elements are denoted by the same reference numerals even though they are depicted in different drawings. In the following description of the present invention, a detailed description of known functions and configurations incorporated herein will be omitted when it may make the subject matter of the present invention rather unclear.

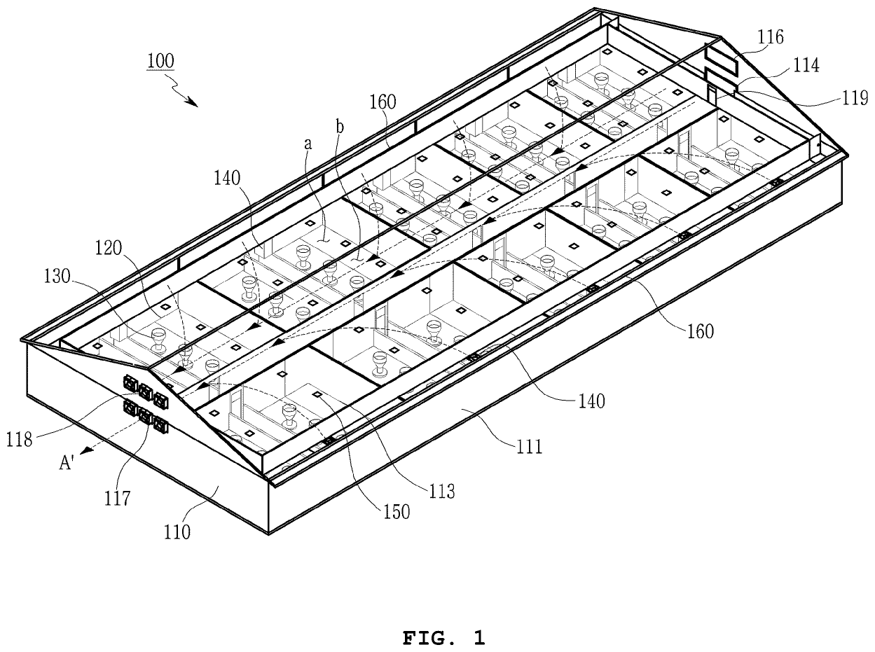

FIG. 1 is a perspective view illustrating the overall configuration of a ventilation system 100 for pig-raising facilities according to the present invention.

As shown in this figure, the ventilation system 100 for pig-raising facilities according to the present invention includes a pig house 110 having a plurality of pig rooms a in which pigs are raised, pits 120 provided at the bottom of the pig house 110 so as to cause excrement of pigs to fall therethrough, feeders 130 provided in the pig rooms a so as to supply feed, a plurality of roof exhaust fans 140 arranged at positions, corresponding to the respective pig rooms a, along the edge regions of an intermediate ceiling 113 of the pig house 110 so as to exhaust contaminated internal air to the outside, a plurality of intermediate ceiling air entry slots 150 arranged on the surface of the intermediate ceiling 113 at constant intervals so as to supply external air A to the pig rooms a, and side air guide pipes 160 coupled to both side walls 111 of the pig house 110 so as to guide the external air A to areas under the pits 120.

Here, the ventilation system 100 for pig-raising facilities according to the present invention may be applied to houses for piglets/growing pigs, houses for breeding sows/pregnant sows in connection with raising of pigs, and houses for other livestock.

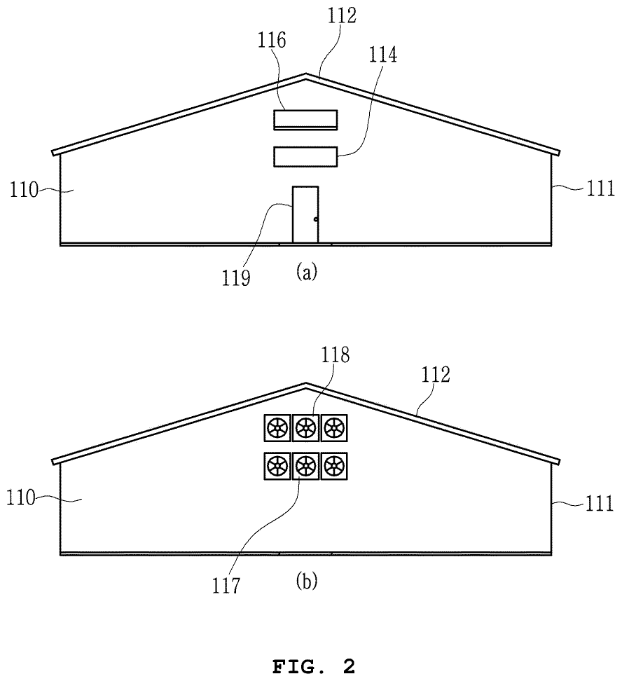

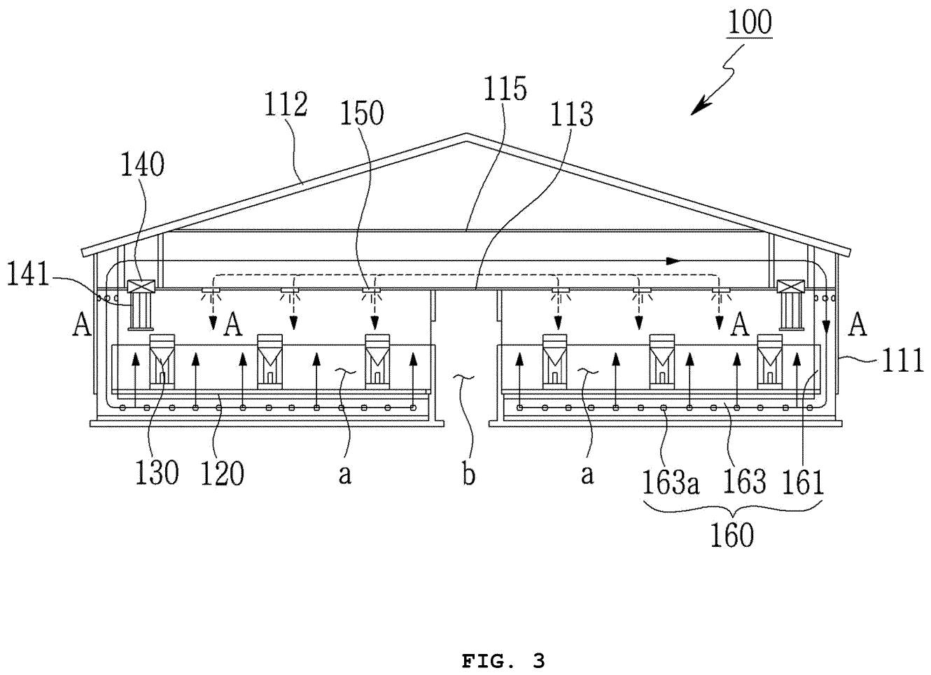

FIG. 2 shows front and rear views illustrating the front and rear surfaces of the pig house 110, FIG. 3 is a cross-sectional view of the pig house 110, and FIG. is a plan view illustrating the inside of the pig house 110.

As shown in (a) of FIG. 2, an entrance door 119 is formed in the front surface of the pig house 110 so as to be opened and closed so that a manager may enter and exit the pig house 110 through the entrance door 110, and a lower window 114 and an upper window 116 are formed above the entrance door 119 so as to be opened and closed.

As shown in FIG. 3, the intermediate ceiling 113 and an upper ceiling 115 are disposed within the pig house 110 so as to be spaced apart from each other. The lower window 114 is provided on the front surface of the pig house 110 so as to correspond to a separation space between the intermediate ceiling 113 and the upper ceiling 115, and the upper window 116 is provided on the front surface of the pig house 110 so as to correspond to a separation space between the upper ceiling 115 and a roof 112.

Thereby, external air A introduced though the lower window 114 may move through the separation space between the intermediate ceiling 113 and the upper ceiling 115, and external air A introduced through the upper window 113 may move through the separation space between the upper ceiling 115 and the roof 112.

Further, as shown in (b) of FIG. 2, lower exhaust fans 117 are provided at a position facing the lower window 114 and upper exhaust fans 118 are provided at a position facing the upper window 116, on the rear surface of the pig house 110.

The lower exhaust fans 117 and the upper exhaust fans 118 are respectively operated by receiving power, and when the lower and upper exhaust fans 117 and 118 are operated, negative pressure is generated and external air may be introduced through the lower window 114 and the upper window 116. Whether or not the lower exhaust fans 117 and the upper exhaust fans 118 are operated may be determined by a manager's manual operation, or be automatically determined in response to a control signal from a controller (not shown).

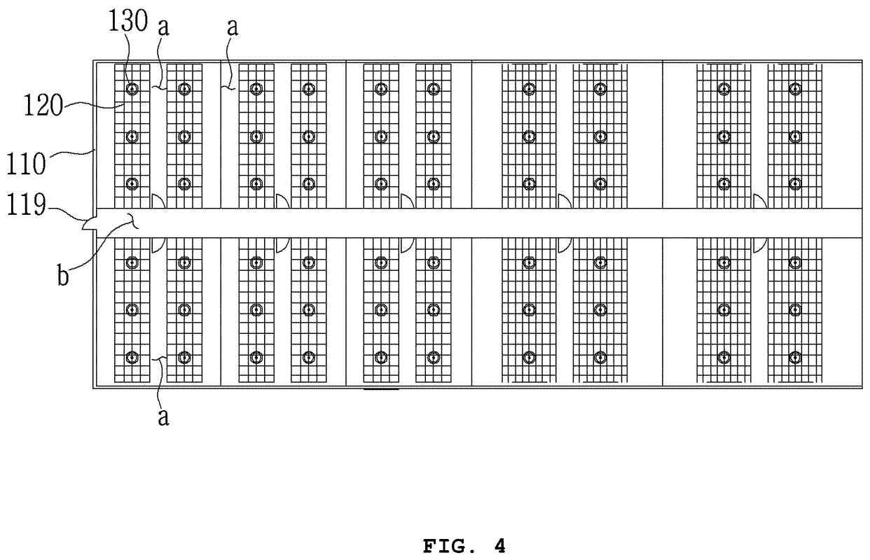

As shown in FIG. 4, a plurality of pig rooms a is provided in the pig house 110, and the aisle b, along which a manager may move, is formed between the neighboring pig rooms a. Each pig room a has an individual entrance door, and the feeders 130 which may supply feed are disposed in each pig room a.

The pits 120 are disposed on the bottom surfaces of the pig rooms a, thereby causing excrement of pigs to fall to the ground therethrough. The pits 120 are formed to the form of a mesh, as shown in the figure.

The roof exhaust fans 140 are arranged at constant intervals along the edge regions of the intermediate ceiling 113, as shown in FIGS. 1 and 3. The roof exhaust fans 140 are provided at positions corresponding to the respective pig rooms a, and exhaust contaminated air A′ inside the pig rooms a. The roof exhaust fans 140 are provided on the upper surfaces of roof exhaust pipes 141 configured to have a designated length downwards.

When the roof exhaust fans 140 are operated, negative pressure is applied through the roof exhaust fans 140, and the contaminated internal air inside the pig house 110 is drawn into the roof exhaust fans 141.

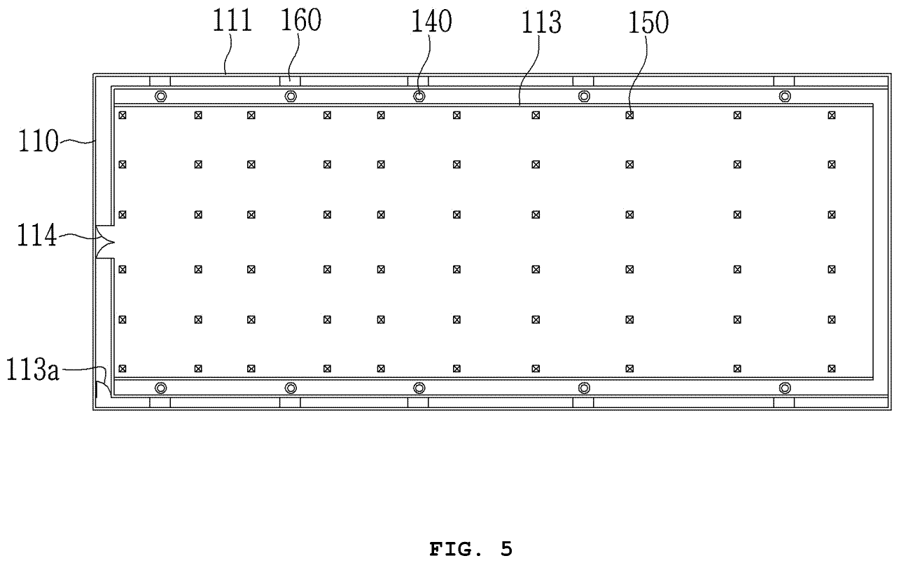

FIG. 5 is a plan view illustrating the configuration of the intermediate ceiling 113. The air entry slots 150 are uniformly formed in a plurality of rows and columns throughout the platy surface of the intermediate ceiling. The air entry slots 150 serve to supply the external air A introduced through the lower window 114 to upper regions of the pig rooms a.

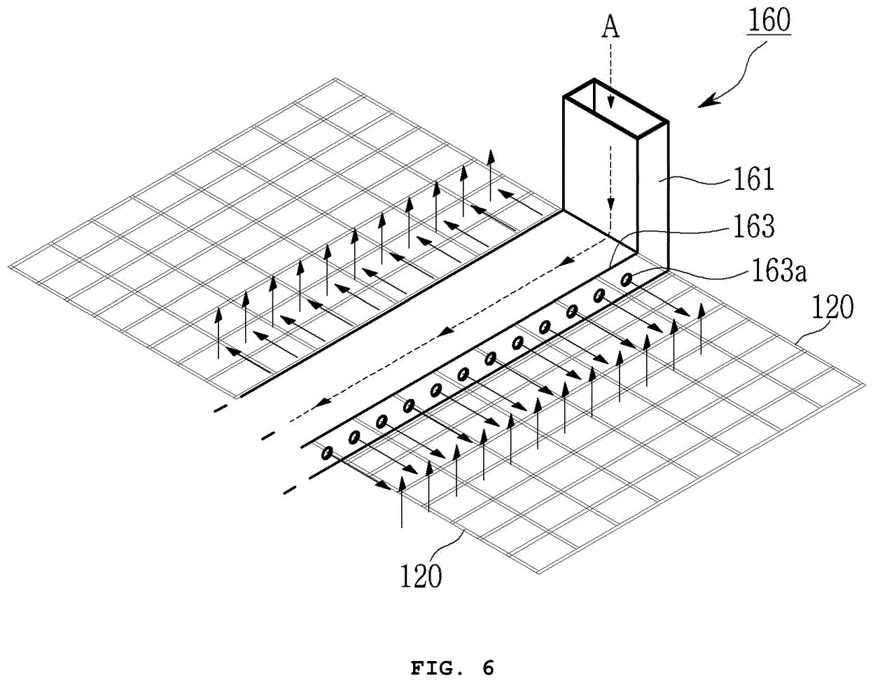

The side air guide pipes 160 are arranged over the side walls 111 and the bottom of the pig house 110, and thus guide the external air A introduced through the lower window 114 to the lower regions of the pig rooms a. FIG. 6 is an example view illustrating the configuration of the side air guide pipe 160 and a supply path of the external air A through the side air guide pipe 160.

As shown in this figure, the side air guide pipe 160 is bent to have an overall L shape. The side air guide pipe 160 includes a vertical pipe 161 arranged vertically inside the side wall 111, and a pit entry pipe 163 bent from the lower end of the vertical pipe 161 to form an aisle b.

As shown in FIG. 3, the upper end of the vertical pipe 161 is disposed so as to communicate with the intermediate ceiling 113. Thereby, the external air A, which is introduced through the lower window 114 and moves to the separation space between the intermediate ceiling 113 and the upper ceiling 115, is supplied to the inside of the vertical pipe 161.

The external air A moves along the vertical pipe 161, and then moves to the pit entry pipe 163. A plurality of air exhaust holes 163a is provided through the front and rear surfaces of the pit entry pipe 163, as shown in FIG. 6.

The pit entry pipe 163 is disposed between the pits 120 of the neighboring pig rooms a. The external air A moved to the pit entry pipe 163 is moved to the areas under the pits 120 through the air exhaust holes 163a. The external air A moved to the areas under the pits 120 is moved upwards through holes formed through the pits 120, thus being supplied to the pig rooms a.

Here, the ventilation system 100 for pig-raising facilities according to the present invention operates an air intake path, through which the external air A is introduced into the ventilation system 100 for pig-raising facilities, and an air exhaust path, through which the contaminated internal air A′ is exhausted to the outside. Further, the ventilation system 100 for pig-raising facilities operates the air intake path differently in the summer, at which time the external temperature is high, and in the winter, at which time the external temperature is low, thereby reducing the energy consumed to perform a heating operation and a cooling operation.

During the daytime in the summer, solar radiation energy is the maximum and the external temperature is high. In order to create an appropriate rearing environment inside the pig house 110, the roof exhaust fans 140 installed in the respective pig rooms a are operated, and the lower exhaust fans 117 are operated. Due to the operation of the roof exhaust fans 140, contaminated air inside the pig rooms a is moved to the separation space between the intermediate ceiling 113 and the upper ceiling 115 through the roof exhaust fans 141, as shown by the dotted line of FIG. 1. Due to the operation of the lower exhaust fans 117, the contaminated air A′ flowing in the separation space between the intermediate ceiling 113 and the upper ceiling 115 is moved to the rear surface of the pig house 110 along both sides of the pig house 110, and is discharged to the outside through the lower exhaust fans 117.

Here, heat accumulated between the intermediate ceiling 113 and the upper ceiling 115 by the solar radiation energy is emitted to the outside by operating the upper exhaust fans 118. That is, as external air is introduced through the upper window 116 due to the operation of the upper exhaust fans 118, the heat accumulated therebetween is emitted to the outside through the upper exhaust fans 118.

The external air A is moved to the inside of the intermediate ceiling 113 through the lower window 114 provided through the front surface of the intermediate ceiling 113, and is moved along the side air guide pipes 160 from the edges of the intermediate ceiling 113 and supplied to the areas under the pits 120 through the air exhaust holes 163a so as to provide a cooler and more comfortable environment to pigs, as indicated in the direction of arrows shown by the solid line of FIG. 3. The external air A supplied to the areas under the pits 120 is introduced into the pig rooms a through the holes formed through the surfaces of the pits 120.

At night in the summer, no solar radiation energy is generated but the external temperature is high due to heat accumulated during the daytime. In order to create an appropriate rearing environment inside the pig house 110, the contaminated air A′ moved to the inside of the intermediate ceiling 113 from the roof exhaust fans 140 installed in the respective pig rooms a is moved to the rear surface of the pig house 110 along both sides of the pig house 110, and is discharged to the outside through the lower exhaust fans 117.

Differently from the operating method for air entry during the daytime in the summer, at night, no solar radiation energy is accumulated in the space between the intermediate ceiling 113 and the upper ceiling 115, and thus, the upper exhaust fans 118 installed on the rear surface of the rear surface of the intermediate ceiling 113 are not separately operated. However, if heat is accumulated inside the roof 112 due to the tendency of hot air to rise, the upper exhaust fans 118 are intermittently operated.

In some cases, a temperature sensor (not shown) may be installed inside the upper ceiling 115, and the upper exhaust fans 118 may be set to be automatically operated when the internal temperature sensed by the temperature sensor is equal to or higher than a predetermined temperature.

The intake path of the external air A at night in the summer is the same as the above-described intake path of the external air A during the daytime in the summer.

In the winter, solar radiation energy is generated but the external temperature is low. In order to create an appropriate rearing environment inside the pig house 110, contaminated air inside the pig rooms a is exhausted to the outside. The exhaust path of the contaminated air inside the pig rooms a is the same as the exhaust path during the daytime in the summer shown in FIG. 1.

Through the intake path of external air, the external air is moved to the intermediate ceiling through the lower window 114 installed in the intermediate ceiling 113. Then, as shown by the dotted line of FIG. 3, the external air is introduced into the pig rooms a through the air entry slots 150 in the intermediate ceiling 113 along a maximally long moving line in preparation for the low external temperature.

In the winter, the external temperature is low, and thus, the upper exhaust fans 118 are not separately operated. (Thereby, drawn air serves to ensure heat insulation from both side exhaust areas and an area above the intermediate ceiling.) Further, energy consumption is reduced using the solar radiation energy reaching the roof.

During the changing of the seasons, such as the spring or the fall, or when the external humidity is high in the rainy season, in order to create an appropriate rearing environment inside the pig house 110, the ventilation paths during the daytime and at night in the summer and the ventilation paths during the daytime and at night in the winter are used in a combined manner based on internal environment data (temperature, humidity, etc.) of the pig house.

Here, whether or not the upper exhaust fans 118, the lower exhaust fans 117 and the roof exhaust fans 140 are operated may be determined by a worker's manual operation, or be automatically determined by the controller (not shown) based on temperature and humidity.

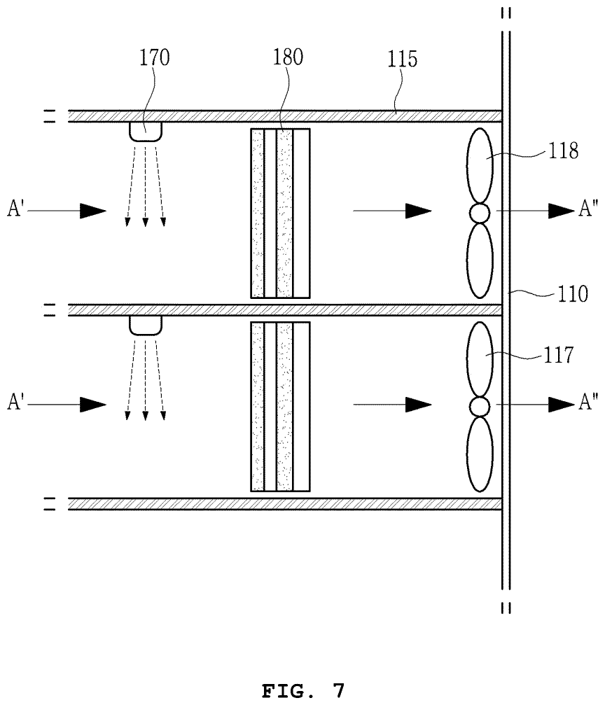

FIG. 7 is an enlarged view illustrating an exhaust path of the contaminated air A′ to the upper exhaust fans 118 or the lower exhaust fans 117.

As shown in this figure, in the ventilation system 100 for pig-raising facilities, the contaminated air A′ is concentratedly exhausted to the upper exhaust fans 118 or the lower exhaust fans 117 provided on the rear surface of the pig house 110. Therefore, purifiers for purifying the contaminated air A′ may be disposed on the moving path of the contaminated air A′ to the upper exhaust fans 118 or the lower exhaust fans 117, thereby being capable of increasing the purification efficiency of the contaminated air A′.

The purifiers may include a UV lamp 170, a deodorizing filter 180, and a washer (not shown). When the contaminated air passes through these purifiers, the contaminated air, from which odors are greatly reduced, is exhausted, thereby reducing air pollution and reducing surrounding civil complaints.

As is apparent from the above description, the present invention provides a ventilation system for pig-raising facilities which uses an air intake path and an air exhaust path which are different from each other. Further, the ventilation system for pig-raising facilities according to the present invention may maintain an appropriate rearing environment in a pig house and minimize energy loss by controlling the air intake path differently in the summer and the winter.

In addition, the ventilation system for pig-raising facilities according to the present invention facilitates purification of contaminated air through the unified the air exhaust path. Thereby, emission of odors from the pig house may be reduced.

The above-described embodiment of the ventilation system for pig-raising facilities according to the present invention is merely exemplary, and those skilled in the art will appreciate that various modifications, additions and substitutions are possible, without departing from the scope and spirit of the invention as disclosed in the accompanying claims. The present invention as described above is not limited by the aspects described herein or the accompanying drawings. Therefore, the scope of the present invention is defined not by the detailed description, but by the claims and their equivalents, and all variations within the scope of the claims and their equivalents are to be construed as being included in the present invention.

<Description of Reference Numerals and Marks>

| | | | |
|---|---|---|---|
| 100: | ventilation system for | 110: | pig house |
| | pig-raising facilities | | |
| 111: | side wall | 112: | roof |
| 113: | intermediate ceiling | 113a: | controllable door |
| 114: | lower window | 115: | upper ceiling |
| 116: | upper window | 117: | lower exhaust fan |
| 118: | upper exhaust fan | 119: | entrance door |
| 120: | pit | 130: | feeder |
| 140: | roof exhaust fan | 141: | roof exhaust pipe |
| 150: | air entry slot | 160: | side air guide pipe |
| 161: | vertical pipe | 163: | pit entry pipe |
| 163a: | air exhaust hole | 170: | UV lamp |
| 180: | deodorizing filter | | |
| a: | pig room | | |
| b: | aisle | | |

1. A ventilation system for pig-raising facilities, comprising:
a pig house (110) comprising a plurality of pig rooms (a) in which pigs are raised, and an intermediate ceiling (113) and an upper ceiling (115) which are spaced apart from each other;
pits (120) provided at bottoms of the pig rooms (a);
a plurality of roof exhaust fans (140) arranged at positions corresponding to the pig rooms (a), along edge regions of the intermediate ceiling (113); and
a plurality of air entry slots (150) provided in a platy surface of the intermediate ceiling (113) at constant intervals, wherein:
a lower window (114) provided between the intermediate ceiling (113) and the upper ceiling (115) so as to introduce external air therethrough and an upper window (116) provided between the upper ceiling (115) and a roof (112) so as to introduce external air therethrough are provided on a front surface of the pig house (110); and
lower exhaust fans (117) configured to face the lower window (114) and upper exhaust fans (118) configured to face the upper window (116) are provided on a rear surface of the pig house (110).

2. The ventilation system for pig-raising facilities according to claim 1, wherein, when the roof exhaust fans (140) and the lower exhaust fans (117) are operated to exhaust air in the pig rooms (a), contaminated air in the pig rooms (a) is moved to the intermediate ceiling (113) through the roof exhaust fans (140), and exhausted to an outside through the lower exhaust fans (117).

3. The ventilation system for pig-raising facilities according to claim 1, further comprising:
side air guide pipes (160) configured to connect side walls (111) of the pig house (110) and an aisle (b) provided between neighboring pig rooms (a), wherein:
each of the side air guide pipes comprises a vertical pipe (161) provided parallel to the side walls (111), and a pit entry pipe (163) bent horizontally from the vertical pipe (161) and disposed between the pits (120) of the neighboring pig rooms (a); and
a plurality of air exhaust holes (163a) configured to exhaust air towards the pits (120) is provided through both sides of the pit entry pipe (163).

4. The ventilation system for pig-raising facilities according to claim 3, wherein, when the upper exhaust fans (118) are operated to allow external air to enter the pig rooms (a) in the summer, the external air is moved to a space between the intermediate ceiling (113) and the upper ceiling (115) through the lower window (114), moved along the side air guide pipes (160), and supplied to areas under the pits (120) through the air exhaust holes (163a).

5. The ventilation system for pig-raising facilities according to claim 4, wherein, in the winter, the external air is introduced into the pig house (110) through the lower window (114), and then introduced into the pig rooms (a) in a downward direction from upper regions thereof through the air entry slots (150) formed in the intermediate ceiling (113).

6. The ventilation system for pig-raising facilities according to claim 1, wherein, when hot air is accumulated in an area above the upper ceiling (115) in the summer, the upper exhaust fans (118) are operated.
